(19) United States
(12) Patent Application Publication
(10) Pub. No.: US 2021/0010517 A1
(43) Pub. Date: Jan. 14, 2021

(54) CONNECTION STRUCTURE OF TRADITIONAL THREAD AND INTERNAL THREAD OUTLINING BIDIRECTIONAL TAPERED OLIVE-LIKE SHAPE HAVING SMALLER LEFT TAPER

(71) Applicant: AMICUS VERITATIS MACHINERY CO., LTD., Taizhou (CN)

(72) Inventor: Yihua You, Taizhou (CN)

(21) Appl. No.: 17/034,244

(22) Filed: Sep. 28, 2020

Related U.S. Application Data
(63) Continuation of application No. PCT/CN2019/081377, filed on Apr. 4, 2019.

(30) Foreign Application Priority Data
Apr. 7, 2018 (CN) 201810303101.4

(51) Int. Cl. F16B 35/04

(52) U.S. Cl. CPC F16B 35/041

(57) ABSTRACT

A connection structure of a traditional thread and an internal thread outlining a bidirectional tapered olive-like shape having a smaller left taper, the internal thread (6) forming a helical shape on the inner surface of a cylindrical body (2), and the complete unit thread forming a bidirectional tapered hole (41). The bidirectional tapered hole has the capability of fitting a traditional external thread (9); the fitted external thread (9) on the outer surface of a columnar body (3) outlines a helical special tapered body (7). The internal thread (6) and the external thread (9) outline the tapered body by means of the tapered hole, such that the bidirectional tapered hole (41) and the special tapered body (7) form a thread pair (10) with joints of tapered pairs till the inner and outer tapered bodies have helical tapered faces with sizing fit or sizing interference.

### CROSS-REFERENCE TO RELATED APPLICATIONS

This application is a continuation of International Patent Application No. PCT/CN2019/081377, filed on Apr. 4, 2019, entitled “Connection Structure of Traditional Thread and Internal Thread Outlining Bidirectional Tapered Olive-like Shape Having Smaller Left Taper” which claims priority to Chinese Patent Application No. 201810303101.4, filed on Apr. 7, 2018. The content of these identified applications are hereby incorporated by references.

### TECHNICAL FIELD

The present disclosure relates to the field of general technology of devices, and more particularly to a connection structure of a traditional thread and an internal thread outlining bidirectional tapered olive-like shape having smaller left taper, namely a connection structure of a traditional thread and an internal thread outlining asymmetrically bidirectional tapered olive-like shape (the conic degree of the left is smaller than that of the right), it is referred to as a bidirectional tapered internal thread and a traditional thread hereinafter.

### BACKGROUND OF THE PRESENT INVENTION

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same thread profile and continuously protruding along a helical line on a cylindrical or conical surface; and the “thread body” refers to a material entity between adjacent flanks. This is also the definition of thread under global consensus.

The modern thread began in 1841 with British Whitworth thread. According to the theory of modern thread technology, the basic condition for self-locking of the thread is that an equivalent friction angle shall not be smaller than a helical rise angle. This is an understanding for the thread technology in modem thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder, and the flatter the inclined plane is, the greater the mechanical advantage is (see FIG. 7) (Jingshan Yang and Xiuya Wang, Discussion on the Principle of Screws, Disquisitiones Arithmeticae of Gauss).

The “principle of inclined plane” of the modem thread is an inclined plane slider model (see FIG. 8) which is established based on the law of inclined plane. It is believed that the thread pair meets the requirements of self-locking when a thread rise angle is less than or equal to the equivalent friction angle under the condition of little change of static load and temperature. The thread rise angle (see FIG. 9), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century, and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF PRESENT INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide a connection structure of a traditional thread and a bidirectional tapered internal thread with reasonable design, simple structure, and excellent connection performance and locking performance with respect to the above problems.

In order to achieve the above object, technical solutions of the present disclosure are as follows. The connection structure of a traditional thread and a bidirectional tapered internal thread is composed of a thread pair, including an internal thread of an asymmetrically bidirectional tapered thread and an external thread of a traditional thread. It is a special thread pair technology that combines the technical characteristics of tapered pairs and helical movements. The internal thread of the bidirectional tapered thread is a thread technology that combines the technical characteristics of the bidirectional tapered body and the helical structure. The bidirectional tapered body is composed of two tapered single-bodies, the left taper direction and the right taper direction of the two tapered single-bodies are on the contrary, and the left taper is smaller than the right taper. The internal thread of the asymmetrically bidirectional tapered thread is the internal thread forming a helical shape on the inner surface of a cylindrical body, and the complete unit thread forming a bidirectional tapered body in an olive-like shape having a large middle part and two small ends, the left taper being smaller than the right taper.

In the traditional thread and the bidirectional tapered internal thread, the definition of the internal thread outlining asymmetrically bidirectional tapered olive-like shape can be expressed as follows, an asymmetrically bidirectional tapered hole on the inner surface of a cylinder or cone, having a specified left taper and a specified right taper, the left taper direction being opposite to the right taper direction, and the left taper being smaller than the right taper, and specially bidirectional tapered bodies in olive-like shapes that have large middle parts and small ends continuously or discontinuously formed along the helical lines. Due to the reasons such as manufacturing, the thread head and thread tail of the asymmetrically bidirectional tapered thread may be incomplete bidirectional tapered bodies. Different from the modern thread technology, the thread technology has changed from the original engagement relationship between the internal thread and the external thread in modern thread to a cohesive relationship between the internal thread and the external thread in the bidirectional tapered thread.

The traditional thread and the bidirectional tapered internal thread include an external thread and an internal thread that are mutually threaded. The internal thread is consisted of bidirectional tapered holes forming a helical shape on the inner surface of a cylindrical body, the external thread is consisted of helical special tapered bodies on the outer surface of a columnar body. That is, the internal thread is consisted of helically bidirectional tapered holes in form of non-entity spaces, and the external thread is consisted of helical special tapered bodies in form of material entities. The non-entity space refers to a space environment capable of accommodating the above-mentioned material entity. The internal thread is an accommodating part, and the external thread is an accommodated part. The internal thread and the external thread are screwed together section by section and joined together till there are bidirectional supporting forces on one end or on both ends, or till the diameters are interference fitted. Whether there are bidirectional supporting forces on both ends at the same time is related to the actual working conditions. That is, the bidirectional tapered holes of the internal thread of a bidirectional tapered thread accommodate the special tapered bodies of the traditional external thread one by one, the special tapered body is formed by the contact with the bidirectional tapered internal thread. Namely the internal thread holds the corresponding external thread section by section.

The thread connection pair is a thread pair formed by a cone pair, and a helical external tapered surface and a helical internal tapered surface are matched with each other to form the cone pair. The internal tapered surface of an internal cone of the bidirectional tapered thread is a bidirectional conical surface. When the bidirectional tapered internal thread and the traditional thread form a thread connection pair, the joint surface where the internal tapered surface of the bidirectional tapered internal thread contacts with a special tapered surface of the traditional external thread is used as the supporting surface. The conical surface is used as the supporting surface to achieve the technical performance of connection. The performances of the thread pair, such as the self-locking performance, the self-positioning performance, the reusability and the fatigue resistance ability, mainly depend on the conical surface and conic degree of the internal thread and the special external conical surface and conic degree of the traditional external thread. The threads are a kind of non-tooth-like thread.

According to the “principle of inclined plane” of the existing thread, the force distributed on the inclined surface is unidirectional, and the internal and external threads are matched by the engagement relationship between the internal tooth bodies and the external tooth bodies. However, in the traditional external thread and the bidirectional tapered internal thread, the cross section of any single cone at left or right end of the internal thread body (namely the bidirectional tapered body), passing through the cone axis, is composed of two prime lines of the cone bidirectionally, namely in a bidirectional state. The prime line is the intersecting line of the conical surface and the plane passing through the cone axis. In the connection structure of the traditional thread and the bidirectional tapered internal thread, the conic principle is reflected by the axial force and the counter-axial force, both of which are synthesized by bidirectional forces. The axial force and the corresponding counter-axial force are against each other, so the internal thread and the external thread are in a cohesive relationship. That is, the thread pair is formed, through the internal thread holding the external thread, namely the tapered holes (internal tapered body) holding the corresponding tapered bodies (external tapered body) pitch by pitch till the holding diameters engagement-fitted to realize self-positioning or till the diameters interference-fitted to realize the self-locking, namely through the tapered holes and the special tapered bodies holding together radially to realize the self-locking or the self-positioning of the internal tapered body and the external tapered body and further to realize the self-locking or the self-positioning of the thread pair. It is different from the traditional thread connection pair consisted of the traditional internal thread and the external thread, the threaded connection performance of which is achieved by abutment between the tooth bodies.

There is a kind of self-locking force when the holding relationship between the internal thread and the external thread reaches a certain condition. The self-locking force is generated by the pressure between the axial force of the internal cone and the counter-axial force of the external cone. That is, when the internal cone and the external cone form a cone pair, the internal conical surface of the internal cone holds the external conical surface of the external cone, so the internal conical surface and the external conical surface are in close contact. The axial force of the internal cone and the counter-axial force of the external cone are the unique force concepts of the bidirectional tapered thread technology (namely the cone pair technology) in the present disclosure.

The internal cone exists in the form of a shaft sleeve. The internal cone can generate an axial force directing to or pressed against the cone axis under the pressure of the external load. The axial force is bidirectionally synthesized by a pair of centripetal forces mirror-image symmetrical about the cone axis and respectively perpendicular to two prime lines of the cone. The axial force passing through the cross section of the cone axis is consisted of two centripetal forces. The two centripetal forces are bidirectionally distributed in mirror image on both sides of the cone axis and symmetrical about the cone axis, and respectively perpendicular to the two prime lines of the cone, and directing to or pressed against the common point of the cone axis. When the above cone and helical structure are combined into a thread and applied to the thread pair, the above-mentioned axial force passing through the cross section of the thread axis is consisted of two centripetal forces. The two centripetal forces are bidirectionally distributed in mirror image and/or approximately in mirror image on both sides of the thread axis and symmetrical about the thread axis, and respectively perpendicular to the two prime lines of the cone, and directing to or pressed against the common point and/or approximate common point of the thread axis. The axial forces are densely distributed around the cone axis and/or the thread axis in an axial direction. The axial force has an axial force angle which is the angle between the two centripetal forces consisting of the axial force. The magnitude of the axial force angle depends on the conic degree of the cone, namely the magnitude of the taper angle.

The external cone exists in the form of a shaft and has a strong ability to absorb various external loads. The external cone can generate a counter-axial force against an axial force of the internal cone. The counter-axial force is bidirectionally synthesized by a pair of counter-centripetal forces mirror-image symmetrical about the cone axis and respectively perpendicular to two prime lines of the cone. The counter-axial force passing through the cross section of the cone axis is consisted of two counter-centripetal forces. The two counter-centripetal forces are bidirectionally distributed in mirror image on both sides of the cone axis and symmetrical about the cone axis, and respectively perpendicular to the two prime lines of the cone, and directing to or pressed against the internal conical surface from the common point of the cone axis. When the above cone and the helical structure are combined into a thread and applied to the thread pair, the above-mentioned counter-axial force passing through the cross section of the thread axis is consisted of two counter-centripetal forces. The two counter-centripetal forces are bidirectionally distributed in mirror image and/or approximately in mirror image on both sides of the thread axis and symmetrical about the thread axis, and respectively perpendicular to the two prime lines of the cone, and directing to or pressed against the conical surface of the internal thread from the common point and/or approximate common point of the thread axis. The counter-axial forces are densely distributed around the cone axis and/or the thread axis in an axial direction. The counter-axial force has a counter-axial force angle which is the angle between the two counter-centripetal forces consisting of the counter-axial force. The magnitude of the counter-axial force angle depends on the conic degree of the cone, namely the magnitude of the taper angle.

The axial force and the counter-axial force are generated when the internal and external cones of the cone pair are in effective contact. Namely, there are always a pair of axial force and corresponding counter-axial force which are against each other, during the effective contacting process of the internal cone and the external cone of the cone pair. Both of the axial force and the counter-axial force are bidirectional forces bidirectionally distributed in mirror image symmetrically about the cone axis and/or the thread axis, but not unidirectional forces. The cone axis and the thread axis can be a coincident axis, namely a same axis and/or an approximately same axis. The counter-axial force and the axial force are collinear but reverse. When the above cone and the helical structure are combined into a thread and applied in a thread pair, the counter-axial force and the axial force are collinear but reverse, and/or approximately collinear but approximately reverse. Pressures can be generated on the contact surface between the internal conical surface and the external conical surface by the axial force and the counter-axial force through the holding relationship between the internal cone and the external cone till reaching the interference fit, and they are densely distributed on the contact surface between the internal conical surface and the external conical surface in a radial direction and evenly distributed in a circumferential direction. When the holding movement between the internal cone and the external cone continues till the cone pair reaches an interference fit, the pressure generated can cohere the internal cone and the external cone. At this time, the pressure can already make the internal cone and the external cone held together to form an approximately integral structure, and the internal and external cones won't be detached from each other under the action of gravity when the external force disappears, even if the direction of the approximately integral structure changes arbitrarily. Because the cone pair or the thread pair has the self-locking ability, and the ability can resist to a certain extent to other external loads that can cause the internal and external cones being detached from each other except the gravity. The cone pair also has the self-positioning ability in the match between the internal cone and the external cone, but not all axial force angle and/or counter-axial force angle can enable the cone pair have the self-locking and self-positioning abilities.

When the axial force angle and/or the counter-axial force angle is less than 180 and greater than 127°, the cone pair has the self-locking ability. When the axial force angle and/or the counter-axial force angle is infinitely close to 180°, the cone pair has the best self-locking ability, and the worst axial load-supporting capacity. When the axial force angle and/or the counter-axial force angle is equal to and/or less than 127° and greater than 0°, the cone pair has a weak self-locking ability and/or doesn't have a self-locking range. When the axial force angle and/or the counter-axial force angle is infinitely close to 0°, the self-locking ability of the cone pair turns gradually attenuated till none self-locking ability at all, and the axial load-supporting capacity increased gradually till reaching the best axial load-supporting capacity.

When the axial force angle and/or the counter-axial force angle is less than 180° and greater than 127°, the cone pair is in a strong self-positioning state, so it is easy to realize the strong self-positioning state of the internal and external cones. When the axial force angle and/or the counter-axial force angle is infinitely close to 180°, the internal and external cones in the cone pair have the best self-positioning abilities. When the axial force angle and/or the counter-axial force angle is equal to and/or less than 127° and greater than 0°, the cone pair is in a weak self-positioning state. When the axial force angle and/or the counter-axial force angle is infinitely close to 0°, the self-positioning abilities of the internal and external cones in the cone pair turn gradually attenuated till approximately none self-positioning ability at all.

In the unidirectional tapered thread of the single tapered body invented by the applicant previously, the conical surface can only support the load at one side because of the irreversible single-sided bidirectional tolerance relation. However, in the bidirectional tapered thread connection pair, the reversible double-sided bidirectional tolerance relation of the bidirectional tapered thread in the bidirectional tapered body can make the left conical surface supporting the load and/or the right conical surface supporting the load and/or the left conical surface and the right conical surface respectively supporting the load and/or the left conical surface and the right conical surface together supporting the load in both directions at the same time. The disordered freedom degree between the tapered holes and the special external tapered bodies can be further restricted. The helical motion allows the connection structure between the bidirectional tapered internal thread and the traditional thread to obtain the necessary ordered freedom degree. Thus a new thread technology is achieved through effectively synthesizing the technical characteristics of the cone pair and the thread pair.

In the use of the connection structure of the bidirectional tapered internal thread and the traditional thread, the special conical surface of the special tapered body of the traditional external thread and the conical surface of the bidirectional tapered hole of the bidirectional tapered internal thread are mutually matched.

In the bidirectional tapered internal thread and traditional thread, not all conic degrees or taper angles of the tapered holes (namely the bidirectional tapered internal thread) can realize the self-locking and/or self-positioning of the thread connection pair. In fact, the connection structure of the bidirectional tapered internal thread and the traditional thread can have self-locking and self-positioning abilities only when the internal cone has a certain conic degree or a certain taper angle. The conic degree includes a left taper and a right taper of the internal thread body. The taper angle includes a left taper angle and a right taper angle of the internal thread body. The left taper corresponds to a left taper angle, namely a first taper angle α1, preferably, 0°<the first taper angle α1<53°. And more preferably, the first taper angle α1 ranges from 2 to 40°. The right taper corresponds to a right taper angle, namely a second taper angle α2, preferably, 0<the second taper angle α2<53°. More preferably, the second taper angle α2 ranges from 2° to 40°. In some specific fields, preferably, 53°≤the second taper angle α2<180°, and more preferably, the second taper angle α2 ranges from 53° to 90°.

The above-mentioned specific field refers to those threaded connection application fields with low self-locking requirements or even no need for self-locking, and/or with low self-positioning requirements, and/or with high axial load-supporting requirements, and/or the transmission connection with necessary anti-lock measures.

In the bidirectional tapered internal thread and the traditional thread, the internal thread is provided on the inner surface of the cylindrical body, the cylindrical body includes a nut body whose inner surface has tapered holes distributed helically, the tapered holes include bidirectional tapered holes, the cylindrical body includes cylindrical bodies and/or non-cylindrical bodies and other workpieces and objects that need to be provided with internal threads on their inner surfaces, the inner surface includes a cylindrical surface and a non-cylindrical surface such as a conical surface.

In the bidirectional tapered internal thread and the traditional thread, the bidirectional tapered hole is the internal thread, which is consisted of two tapered holes with same bottom surfaces and same top surfaces but of different conic heights. The two tapered holes are symmetrically engaged with each other at bottom surfaces in contrary directions to form a helical thread, and the top surfaces are located at two ends of the bidirectional tapered hole. In an asymmetrically bidirectional tapered thread in olive-like shape, the top surfaces of adjacent bidirectional-tapered holes are respectively engaged with each other in helical shape to form a screw thread. The internal thread comprises a first helical conical surface of the tapered hole, a second helical conical surface of the tapered hole and an internal helical line. In the cross section passing through the thread axis, the complete unit thread of the asymmetrically bidirectional tapered internal thread is a special bidirectional-tapered body in an olive-like shape having a large middle part and two small ends and the left taper being smaller than the right taper. The bidirectional tapered hole comprises conical surfaces of the bidirectional tapered hole. The angle between two prime lines of the first helical conical surface of the tapered hole (namely the left conical surface) is the first taper angle α1. The first helical conical surface of the tapered hole forms a left taper and is subjected to a left-direction distribution. The angle between two prime lines of the second helical conical surface of the tapered hole (namely the right conical surface) is the second taper angle α2. The second helical conical surface of the tapered hole forms a right taper and is subjected to a right-direction distribution. The tapered direction corresponding to the first taper angle α1 is opposite to the tapered direction corresponding to the second taper angle α2. The prime line is the intersecting line of the conical surface and the plane passing through the cone axis. The shape formed by the first helical conical surface and the second helical conical surface of the bidirectional tapered hole is the same as the shape of the helical outer surface of a cyclotron body formed by two inclined sides of a right-angle trapezoid union. The right-angle trapezoid union comprises two right-angle trapezoids with same bottom sides and same top sides but different right-angle sides, the two right-angle trapezoids are connected to each other at the bottom sides symmetrically and coincident with the plane passing through the central axis of the cylindrical body. The cyclotron body is formed by rotating the right-angle trapezoid union in a circumferential direction at an even speed around its right-angle side and at the same time moving the right-angle trapezoid union axially towards the central axis of the cylindrical body at an even speed. The right-angle trapezoid union is a special body which comprises two right-angle trapezoids with same bottom sides and same top sides but different right-angle sides, the two right-angle trapezoids are connected to each other at the bottom sides symmetrically, and the top sides are respectively located at two ends of the right-angle trapezoid union.

Due to the unique technical characteristics and advantages of using a tapered body or tapered hole as a thread body, the bidirectional tapered internal thread has a strong ability to fit different kinds of threads. It has the ability to assimilate the traditional thread to be matched into a special tapered thread with the same technical characteristics and properties as oneself. The fitted traditional thread assimilated by the tapered thread is dissimilated traditional thread. Although the dissimilated traditional thread looks similar as the traditional thread with tooth bodies, it has no substantial technical content of the thread body of the traditional thread. The thread body has changed from the traditional threaded tooth to a special tapered body, and the special tapered body has the natures and technical characteristics of the tapered body, namely the thread body with tapered thread. There is a special conical surface on the radial direction of the special tapered body, matching with the helical conical surface of the tapered thread. The above-mentioned traditional thread includes a triangular thread, a trapezoid thread, a zigzag thread, a rectangular thread, an arc thread, or any other shape-like thread which can be screwed with the above bidirectional tapered thread to make up a thread connection pair, without the limitation to the above.

When the traditional external thread and the bidirectional tapered internal thread cooperate to form a thread connection pair, the traditional external thread at this time is no longer a traditional thread in the original sense, but a special tapered thread assimilated by the tapered internal thread. The contact portion between the external thread and the bidirectional tapered internal thread forms the outer surface of the special tapered body of the traditional external thread in the thread connection pair, which can match the helical conical surface of the tapered thread, namely the special tapered body has a special conical surface. With the increase of the screwing times, the effective area of the special conical surface on the special cone of the traditional external thread will continue to increase, namely the special conical surface will continue to increase, and tend to have a greater contact portion with the conical surface of the tapered hole of the bidirectional tapered internal thread, thus essentially forming a special tapered body that has the technical spirit of the present disclosure even if the tapered shape is incomplete. Further, the special tapered body is a thread body assimilated from the traditional external thread by the bidirectional tapered internal thread due to holding contact therebetween. It is a special tapered body transformed from the traditional external thread with tooth bodies. The above-mentioned special tapered body has an outer surface in its radial direction, namely a special conical surface, which can match the conical surface of the bidirectional tapered hole. The thread connection pair is formed by a cone pair which is formed through the engagement of the special external conical surface in a helical shape and the internal conical surface in a helical shape. The special external conical surface in a helical shape is a special conical surface of the special tapered body formed due to the contact of the traditional external thread and the bidirectional tapered internal thread. The internal conical surface in a helical shape is the internal conical surface of the bidirectional tapered internal thread. The internal conical surface is the internal tapered face of the internal tapered body. The helical conical surface of the tapered hole of the bidirectional tapered internal thread is a bidirectional conical surface. The assimilated traditional thread is a dissimilated traditional thread and a special tapered thread. The external conical surface of this special tapered thread (namely the special conical surface of the traditional external thread) first appears in the form of a line, and the area gradually increases as the contacting times of the traditional external thread tooth and the tapered hole of the bidirectional tapered internal thread increase. Namely, the special conical surface of the traditional external thread constantly changes from microscopical surface (macroscopical line) to macroscopical surface. Or the external conical surface that matches the bidirectional tapered internal thread can be directly provided at the tooth of the traditional external thread. These are in the spirit of the present disclosure.

In the bidirectional tapered internal thread and the traditional thread, the external thread is provided on the outer surface of the columnar body. The columnar body includes a screw body, and the outer surface of the screw body has special tapered bodies distributed in a helical shape. The special tapered bodies are formed due to the contact between the traditional external thread and the bidirectional tapered internal thread. The special tapered bodies are provided with special conical surfaces. The columnar body can be solid or hollow, including cylinders and/or non-cylinders and other workpieces and objects that need to be provided with threads on their outer surfaces. The outer surfaces include cylindrical surfaces and non-cylindrical surfaces such as conical surfaces.

When the connection structure of the bidirectional tapered internal thread and the traditional thread is in use, its relationship with the workpiece includes rigid connection and non-rigid connection. The rigid connection means that the nut supporting surface and the workpiece supporting surface are mutually supported, including structural forms such as a single nut and a double nut. The non-rigid connection means that, the end surfaces of the two nuts facing to each other are mutually supported, and/or there is a gasket between the end surfaces of the two nuts facing to each other, which are indirectly supported. The non-rigid connection is mainly used in non-rigid materials or non-rigid connection workpieces such as transmission parts or to meet the needs through double nuts installation. The workpiece refers to the connected object including the workpiece, and the gasket refers to the spacer including the gasket.

In the bidirectional tapered internal thread and the traditional thread, when the connection structure of the traditional threaded bolt and the double nuts with bidirectional tapered thread is used and is rigidly connected with the fastened workpiece, the tapered-thread supporting surfaces are different. When the cylindrical body is located at the left side of the fastened workpiece, namely the left end surface of the fastened workpiece and the right end surface of the cylindrical body (namely the left nut body) are the locking support surfaces between the left nut body and the fastened workpiece, the right helical conical surface of the bidirectional tapered thread of the left nut body is the tapered-thread supporting surface, namely the second helical conical surface of the tapered hole of the bidirectional tapered internal thread and the special conical surface of the traditional external thread are the tapered-thread supporting surfaces, and the second helical conical surface of the tapered hole and the special conical surface of the traditional external thread are mutually supported. When the cylindrical body is located at the right side of the fastened workpiece, namely the right end surface of the fastened workpiece and the left end surface of the cylindrical body (namely the right nut body) are the locking support surfaces between the right nut body and the fastened workpiece, the left helical conical surface of the bidirectional tapered thread of the right nut body is the tapered-thread supporting surface, namely the first helical conical surface of the tapered hole of the bidirectional tapered internal thread and the special conical surface of the traditional external thread are the tapered-thread supporting surfaces, and the first helical conical surface of the tapered hole and the special conical surface of the traditional external thread are mutually supported.

In the bidirectional tapered internal thread and the traditional thread, the connection structure of the traditional threaded bolt and the single nut with bidirectional tapered thread is used and is rigidly connected with the fastened workpiece. When the hexagonal head of the bolt is on the left, the cylindrical body (namely the nut body or the single nut) is located at the right side of the fastened workpiece. When the connection structure of the bolt and the single nut is in use, the right end surface of the workpiece and the left end surface of the nut body are locking support surfaces of the nut body and the fastened workpiece, the left helical conical surface of the bidirectional tapered thread of the nut body is the tapered-thread supporting surface, namely the first helical conical surface of the tapered hole of the bidirectional tapered internal thread and the special conical surface of the traditional external thread are tapered-thread supporting surfaces, and the first helical conical surface of the tapered hole and the special conical surface of the traditional external thread are mutually supported. When the hexagonal head of the bolt is on the right, the cylindrical body (namely the nut body or the single nut) is located at the left of the fastened workpiece. When the connection structure of the bolt and the single nut is in use, the left end surface of the workpiece and the right end surface of the nut body are locking support surfaces of the nut body and the fastened workpiece, the right helical conical surface of the bidirectional tapered thread of the nut body is the tapered-thread supporting surface, namely the second helical conical surface of the tapered hole of the bidirectional tapered internal thread and the special conical surface of the traditional external thread are tapered-thread supporting surfaces, and the second helical conical surface of the tapered hole and the special conical surface of the traditional external thread are mutually supported.

In the bidirectional tapered internal thread and the traditional thread, when the connection structure of the traditional threaded bolt and the double nuts with bidirectional tapered thread is used and is non-rigidly connected with the fastened workpiece, the tapered-thread supporting surfaces are different. The cylindrical body comprises a left nut body and a right nut body. The right end surface of the left nut body faces to and contacts directly with the left end surface of the right nut body, and they are mutually supported and locked. When the right end surface of the left nut body is the locking support surface, the right helical conical surface of the bidirectional tapered thread of the left nut body is the tapered-thread supporting surface, namely the second helical conical surface of the tapered hole of the bidirectional tapered internal thread and the special conical surface of the traditional external thread are tapered-thread supporting surfaces, and the second helical conical surface of the tapered hole and the special conical surface of the traditional external thread are mutually supported. When the left end surface of the right nut body is the locking support surface, the left helical conical surface of the bidirectional tapered thread of the right nut body is the tapered-thread supporting surface, namely the first helical conical surface of the tapered hole of the bidirectional tapered internal thread and the special conical surface of the traditional external thread are tapered-thread supporting surfaces, and the first helical conical surface of the tapered hole and the special conical surface of the traditional external thread are mutually supported.

In the bidirectional tapered internal thread and the traditional thread, when the connection structure of the traditional threaded bolt and the double nuts with bidirectional tapered thread is used and is non-rigidly connected with the fastened workpiece, the tapered-thread supporting surfaces are different. The cylindrical body comprises a left nut body and a right nut body, and a spacer such as a gasket is provided between two cylindrical bodies (namely the left nut body and the right nut body). The right end surface of the left nut body faces to and contacts indirectly with the left end surface of the right nut body through the gasket, and they are mutually supported and locked. When the cylindrical body is located at the left side of the gasket, namely the left surface of the gasket and the right end surface of the left nut body are the locking support surfaces of the left nut body, the right helical conical surface of the bidirectional tapered thread of the left nut body is the tapered-thread supporting surface, namely the second helical conical surface of the tapered hole of the bidirectional tapered internal thread and the special conical surface of the traditional external thread are tapered-thread supporting surfaces, and the second helical conical surface of the tapered hole and the special conical surface of the traditional external thread are mutually supported. When the cylindrical body is located at the right side of the gasket, namely the right surface of the gasket and the left end surface of the right nut body are the locking support surfaces of the right nut body, the left helical conical surface of the bidirectional tapered thread of the right nut body is the tapered-thread supporting surface, namely the first helical conical surface of the tapered hole of the bidirectional tapered internal thread and the special conical surface of the traditional external thread are tapered-thread supporting surfaces, and the first helical conical surface of the tapered hole and the special conical surface of the traditional external thread are mutually supported.

Further, when the internal cylindrical body (namely the nut body adjacent to the fastened workpiece) has been effectively combined with the columnar body (namely the screw body or the bolt), namely the internal thread and the external thread which consist of the thread connection pair are effectively held together, the external cylindrical body (namely the nut body that is not adjacent to the fastened workpiece) can be kept intact and/or removed to leave only one nut according to the application conditions (for example, the application field that has requires for the lightweight of the equipment, or the application field that doesn't need double nuts to ensure the connection reliability, or other application fields). The removed nut body is not used as a connection nut but only as an installation process nut. The internal thread of the installation process nut can be processed to a bidirectional tapered thread, or an unidirectional tapered thread, or any other traditional thread that can be screwed with the thread of the bolt, such as a triangular thread, a trapezoid thread, a zigzag thread, etc., but not limited to the above. Any suitable thread can be applied to ensure the connection reliability. The thread connection pair is a closed-loop fastening technology system. When the internal thread and the external thread of the thread connection pair are effectively combined together, the thread connection pair will become an independent technical system, but not relying on the technical compensation of a third party to ensure the technical effectiveness of the connection technology system. That is, the effectiveness of the thread connection pair will not be affected even if there is no support from other objects, such as when there is a gap between the thread connection pair and the fastened workpiece, which will help to greatly reduce the weight of the equipment, remove the invalid load, and improve the technical performance of the equipment such as the effective load capacity, the braking performance, and the energy saving and emission reducing ability. This is a unique technical advantage that is not available in other thread technology, but only available in the connection structure of the bidirectional tapered internal thread and the traditional thread no matter it is rigidly or non-rigidly connected with the fastened workpiece.

In the bidirectional tapered internal thread and the traditional thread, when in a transmission connection, it can support the load bidirectionally through the screwed connection between the bidirectional tapered hole and the special tapered body of the traditional external thread. When the external thread and the internal thread form a thread pair, there must be clearance between the bidirectional tapered hole and the special tapered body of the traditional external thread. If there is oil or other lubrication medium between the internal thread and the external thread, it will be easy to form a supporting oil film. The clearance is conducive to the formation of the supporting oil film. The internal thread and the traditional thread are applied to the transmission connection, which is equivalent to a set of sliding bearing pairs composed of one and/or several pairs of sliding bearings. Each section of the bidirectional tapered internal thread bidirectionally accommodates a corresponding section of the traditional external thread, which form a pair of sliding bearings. The amount of the formed sliding bearings can be adjusted according to the application conditions. Namely, the amount of the accommodating and accommodated thread sections in effective bidirectional engagement or embracement of the bidirectional tapered internal thread and the traditional external thread, can be designed according to the application conditions. The tapered hole of the tapered internal thread accommodates the special tapered body of the traditional external thread, and they are positioned in multiple directions such as radial, axial, angular, and circumferential directions. Preferably, the special tapered body is accommodated by the bidirectional tapered hole, and is primarily positioned in the radial and circumferential directions, and subsidiarily positioned in the axial and angular directions, achieving the multi-directional positioning of the internal and external cones till the conical surface of the bidirectional tapered hole and the special conical surface of the special tapered body are held to achieve the self-positioning or till the diameters are interference fitted to achieve the self-locking. The special technology of the combination of the cone pair and thread pair can ensure the accuracy, efficiency and reliability of the transmission connection of the traditional thread and the tapered thread, especially the bidirectional tapered internal thread.

In the bidirectional tapered internal thread and the traditional thread, when in a fastening or sealing connection, the technical performance is achieved through the screw connection between the bidirectional tapered hole of the tapered internal thread and the special tapered body of the traditional external thread, namely through the first helical conical surface of the tapered hole and the special conical surface of the special tapered body of the traditional external thread sizing till interference fit, and/or the second helical conical surface of the tapered hole and the special conical surface of the special tapered body of the traditional external thread sizing till interference fit. According to the application conditions, it can support load in one direction and/or simultaneously in two directions. Under the guide of the helical line, the inner and outer diameters of the internal cone and the special external cone of the traditional external thread are centered till the first helical conical surface of the tapered hole and the special conical surface of the special tapered body of the traditional external thread are held together to achieve the interference contact, and/or till the second helical conical surface of the tapered hole and the special conical surface of the special tapered body of the traditional external thread are held together to achieve the interference contact. That is, the self-locking is achieved through the bidirectional tapered hole of the tapered internal thread accommodating the special tapered body of the traditional external thread, and they are positioned in multiple directions such as radial, axial, angular, and circumferential directions. Preferably, the special tapered body is accommodated by the bidirectional tapered hole, and they are primarily positioned in the radial and circumferential directions, and subsidiarily positioned in the axial and angular directions, achieving the multi-directional positioning of the inner and external cones till the conical surface of the bidirectional tapered hole and the special conical surface of the special tapered body are held to achieve the self-positioning or till the diameters are interference fitted to achieve the self-locking. The special technology of the combination of the cone pair and thread pair can ensure the transmission accuracy and efficiency and reliability of the connection structure of the traditional thread and the tapered thread, especially the bidirectional tapered internal thread, thus achieving the technical performances of the mechanical structures, such as connection, locking, anti-loosening, bearing, fatigue and sealing.

Therefore, the technical performances of the connection structure of the bidirectional tapered internal thread and the traditional thread, such as the accuracy, efficiency, load-supporting capacity, locking force of self-locking, anti-loosening capacity, and sealing performance, are related to the first taper angle α1 and the second taper angle α2. The first taper angle α1 corresponds to the first helical conical surface of the tapered hole and the left taper formed by it. The second taper angle α2 corresponds to the second helical conical surface of the tapered hole and the right taper formed by it. The technical performances are also related to the special external tapered surface of the traditional external thread and its conic degree, and the special external tapered surface is formed by the contact of the bidirectional tapered internal thread with the traditional external thread. The friction coefficient, processing quality, and application conditions of the material of the columnar body and the cylindrical body also have a certain effect on the technical performances.

In the above bidirectional tapered internal thread and the traditional thread, when the right-angle trapezoid union makes one revolution at a constant speed, the moving distance of the right-angle trapezoid union in the axial direction is at least double of the sum of the lengths of the right-angle sides of two right-angle trapezoids with different right-angle sides, same bottom sides and same top sides. This structure ensures that the first helical conical surface of the tapered hole and the second helical conical surface of the tapered hole have sufficient lengths, so as to ensure a sufficiently effective contact area, strength, and efficiency required for helical movement when the conical surface of the bidirectional tapered hole is fitted with the special conical surface of the traditional external thread.

In the above bidirectional tapered internal thread and the traditional thread, when the right-angle trapezoid union makes one revolution at a constant speed, the moving distance of the right-angle trapezoid union in the axial direction is equal to the sum of the lengths of the right-angle sides of two right-angle trapezoids with different right-angle sides, same bottom sides and same top sides. This structure ensures that the first helical conical surface of the tapered hole and the second helical conical surface of the tapered hole have sufficient lengths, so as to ensure a sufficiently effective contact area, strength, and efficiency required for helical movement when the conical surface of the bidirectional tapered hole is fitted with the special conical surface of the traditional external thread.

In the bidirectional tapered internal thread and the traditional thread, the first helical conical surface of the tapered hole and the second helical conical surface of the tapered hole are both continuous helical surfaces or discontinuous helical surfaces.

In the bidirectional tapered internal thread and the traditional thread, the special conical surface of the special tapered body is a continuous helical surface or a discontinuous helical surface.

In the bidirectional tapered internal thread and the traditional thread, one end and/or both ends of the columnar body may be the screw-in end screwed into the connection hole of the cylindrical body, the thread connection can be realized through the contact and/or interference fit between the first helical conical surface of the tapered internal thread and the special conical surface of the traditional external thread, and/or through the contact and/or interference fit between the second helical conical surface of the tapered internal thread and the special conical surface of the traditional external thread.

In the bidirectional tapered internal thread and the traditional thread, one end of the columnar body is provided with a head having a size larger than the outer diameter of the columnar, and/or one end and/or each end of the columnar body is provided with a head having a size smaller than the minor diameter of the bidirectional tapered external thread of the columnar body (namely the screw body), and the connection hole is a thread hole provided on the nut. That is, part of the columnar body connected to the head forms a bolt, the part without a head and/or the columnar body having heads at both ends smaller than the minor diameter of the bidirectional tapered external thread and/or the columnar body having no thread in the middle but having bidirectional tapered external thread on both ends is a stud. The connection hole is provided in the nut.

Compared with the existing technology, the advantages of the connection structure of the bidirectional tapered internal thread and the traditional thread are as follows. It has a reasonable design and a simple structure. The fastening and connection functions can be achieved through centering the inner and outer diameters of bidirectional load-supporting cone pair or sizing the bidirectional load-supporting cone pair till interference fit, wherein the cone pair is consisted of the internal and external cones. Besides, it is easy to operate, has a large locking force, a large load-supporting value, a good anti-loosening performance, a high transmission efficiency and precision, a good mechanical sealing effect, a good stability, an ability to prevent loosening during connection, and the self-locking and self-positioning functions.

### DESCRIPTION OF THE DRAWINGS

FIG. 1 is a schematic diagram of a connection pair of a traditional thread and an internal thread outlining asymmetrically bidirectional tapered olive-like shape (the conic degree of the left is smaller than that of the right) according to the first embodiment of the present invention.

FIG. 2 is a schematic diagram of an internal thread outlining asymmetrically bidirectional tapered olive-like shape (the conic degree of the left is smaller than that of the right) and its complete unit thread according to the first embodiment of the present invention.

FIG. 3 is a schematic diagram of a connection structure of a bolt with a traditional thread and double nuts with internal threads outlining asymmetrically bidirectional tapered olive-like shape (the conic degree of the left is smaller than that of the right) according to the second embodiment of the present invention.

FIG. 4 is a schematic diagram of a connection structure of a bolt with a traditional thread and single nut with an internal thread outlining asymmetrically bidirectional tapered olive-like shape (the conic degree of the left is smaller than that of the right) according to the third embodiment of the present invention.

FIG. 5 is a schematic diagram of a connection structure of a bolt with a traditional thread and double nuts with internal threads outlining asymmetrically bidirectional tapered olive-like shape (the conic degree of the left is smaller than that of the right) according to the fourth embodiment of the present invention.

FIG. 6 is a schematic diagram of a connection structure of a bolt with a traditional thread and double nuts (a gasket provided therebetween) with internal threads outlining asymmetrically bidirectional tapered olive-like shape (the conic degree of the left is smaller than that of the right) according to the fifth embodiment of the present invention.

FIG. 7 is a diagram of “the thread in the conventional thread technology is an inclined plane on the surface of a cylinder or cone” involved in the background art of the present invention.

FIG. 8 is a diagram of “the inclined plane slider model in the “principle of inclined plane” which is the conventional thread technology” involved in the background art of the present invention.

FIG. 9 is a diagram of “the thread rise angle in the conventional thread technology” involved in the background art of the present invention.

In the figures, tapered thread 1, cylindrical body 2, nut body 21, nut body 22, columnar body 3, screw body 31, tapered hole 4, bidirectional tapered hole 41, conical surface 42 of bidirectional tapered hole, first helical conical surface 421 of tapered hole, first taper angle α1, second helical conical surface 422 of tapered hole, second taper angle α2, internal helical line 5, internal thread 6, special tapered body 7, special conical surface 72, external thread 9, olive-like shape 93, left taper 95, right taper 96, left-direction distribution 97, right-direction distribution 98, thread connection pair and/or thread pair 10, clearance 101, locking support surface 111, locking support surface 112, tapered-thread supporting surface 122, tapered-thread supporting surface 121, workpiece 130, locking direction 131 of nut body, gasket 132, cone axis 01, thread axis 02, slider A on the inclined surface, inclined surface B, gravity G, gravity component G1 along the inclined plane, friction force F, thread rise angle φ, equivalent friction angle P, major diameter d of traditional external thread, minor diameter d1 of traditional external thread, median diameter d2 of traditional external thread.

### DETAILED DESCRIPTION OF PREFERRED EMBODIMENTS

The present disclosure will be further described in detail in combination with the attached drawings and the specific embodiments in the following.

### The First Embodiment

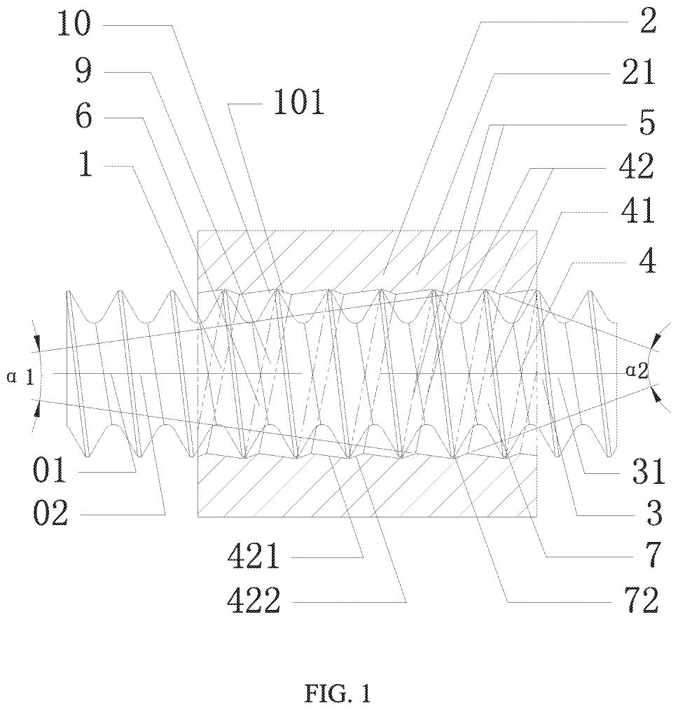

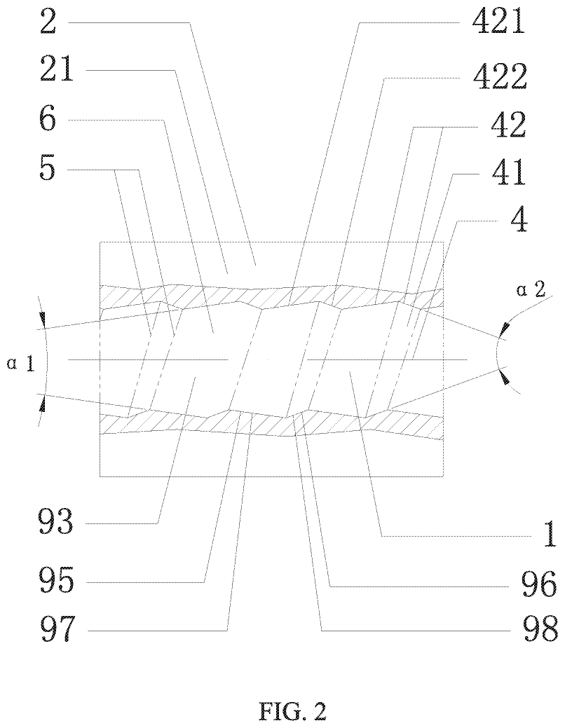

As shown in FIG. 1 and FIG. 2, in the embodiment, a connection structure of an asymmetrically bidirectional tapered internal thread 6 and a traditional external thread 9 is used. The connection pair 10 of bidirectional tapered internal thread and the traditional thread comprises bidirectional tapered holes 41 helically distributed on the inner surface of the cylindrical body 2 and special tapered bodies 7 helically distributed on the outer surface of the columnar body 3, the special tapered body 7 is formed from the contact between the traditional external thread 9 and the bidirectional tapered internal thread 6. Namely, the connection pair 10 comprises an external thread 9 and an internal thread 6 that are threaded with each other, and the internal thread 6 is presented as bidirectional tapered holes 41 distributed helically and as non-entity spaces, the external thread 9 is presented as special tapered bodies 7 distributed helically and as material entities. The internal thread 6 is an accommodating part, and the external thread 9 is an accommodated part. The internal thread 6 and the external thread 9 are screwed together pitch by pitch and joined together till interference fit. The bidirectional tapered holes 41 accommodate the special tapered bodies 7 of the traditional external thread 9 one by one, the special tapered bodies 7 are formed by the contact with the bidirectional tapered internal thread. The bidirectional accommodation can restrict the disordered freedom degree between the tapered holes 4 and the special tapered bodies 7 of the traditional external thread. However, the helical motion allows the connection pair 10 of the bidirectional tapered internal thread and the traditional thread to obtain the necessary ordered freedom degree, and thus effectively synthesizing the technical characteristics of the cone pair and the thread pair.

In the embodiment, in the use of the connection pair 10 of the bidirectional tapered internal thread and the traditional thread, the special conical surface 72 of the special tapered body 7 of the traditional external thread 9 and the conical surface 42 of the bidirectional tapered hole are mutually matched.

In the embodiment of the connection pair of asymmetrically bidirectional tapered internal thread and traditional thread, the thread connection pair 10 can have the self-locking and self-positioning abilities only when the tapered hole 4 has a certain conic degree or the tapered body has a certain taper angle. The conic degree includes a left taper 95 and a right taper 96, and the taper angle includes a left taper angle and a right taper angle. The left taper 95 corresponds to the left taper angle, namely a first taper angle α1, preferably, 0°<the first taper angle α1<53°. And more preferably, the first taper angle α1 ranges from 2 to 40°. The right taper 96 corresponds to the right taper angle, namely a second taper angle α2, preferably, 0°<the second taper angle α1<53°. More preferably, the second taper angle α2 ranges from 2° to 40° In some specific fields, such as the connection application fields with no need for self-locking and/or with low self-positioning requirements, and/or with high axial load-supporting requirements, preferably, 53°≤the second taper angle α2<180°, and more preferably, the second taper angle α2 ranges from 53° to 90°.

The external thread 9 is provided on the outer surface of the columnar body 3. The columnar body 3 includes a screw body 31, the outer surface of the screw body 31 is provided with a traditional external thread 9. The traditional external thread 9 refers to the geometric threads including a triangular thread, a trapezoid thread, a zigzag thread, etc., which can be screwed with the above-mentioned bidirectional tapered thread 1 to form the thread connection pair 10. When the traditional external thread 9 and the bidirectional tapered internal thread 6 are cooperated to form the thread connection pair 10, the traditional external thread 9 is no longer a traditional thread in the original sense, but a special form of tapered thread 1. Its contact portion with the bidirectional tapered internal thread 6 forms the special tapered bodies 7 of the traditional external thread 9 in the thread connection pair 10. A special tapered surface 72 is provided on the special tapered body 7. With the increase of the screwing times, the effective area of the special conical surface 72 on the special tapered body 7 of the traditional external thread 9 will continue to increase, namely the special conical surface 72 will continue to increase, and tend to have a greater contact portion with the conical surface 42 of the tapered hole of the bidirectional tapered internal thread, thus essentially forming the special tapered body 7 that has the technical spirit of the present disclosure even if the tapered shape is incomplete. The external conical surface (namely the special conical surface 72 of the traditional external thread 9) first appears in the form of a line, and the area gradually increases as the contacting times of the tooth of the traditional external thread 9 and the tapered hole 4 of the bidirectional tapered internal thread 6 increase, namely the special conical surface 72 of the traditional external thread 9 increases gradually from line to plane. Or the external conical surface that matches the bidirectional tapered internal thread 6 can be directly provided at the tooth of the traditional external thread 9. These are in the spirit of the present disclosure. The columnar body 3 can be solid or hollow, including cylinders, cones, tubes and other workpieces and objects that need to be provided with external threads on their outer surfaces.

The bidirectional tapered internal thread 6 is provided on the inner surface of the cylindrical body 2. The cylindrical body 2 includes a nut body 21 whose inner surface has tapered holes 4 distributed helically. The tapered holes include bidirectional tapered holes 41. The cylindrical body 2 includes cylindrical bodies and/or non-cylindrical bodies and other workpieces and objects that need to be provided with internal threads on their inner surfaces.

The bidirectional tapered hole 41 in olive-like shape 93 is consisted of two tapered holes with same bottom surfaces and same top surfaces but of different conic heights. The two tapered holes are symmetrically engaged with each other at bottom surfaces in contrary directions, and the top surfaces are located at two ends of the bidirectional tapered hole 41. In the asymmetrically bidirectional tapered thread 1, the top surfaces of adjacent bidirectional-tapered holes 41 are respectively engaged with each other. The internal thread 6 comprises a first helical conical surface 421 of the tapered hole, a second helical conical surface 422 of the tapered hole and an internal helical line 5. In the cross section passing through the thread axis 02, a complete single section of the asymmetrically bidirectional tapered internal thread 6 is a special bidirectional-tapered body in olive-like shape 93 having a large middle part and two small ends. The bidirectional tapered hole 41 comprises conical surfaces 42 of the bidirectional tapered hole. The angle between two prime lines of the first helical conical surface 421 of the tapered hole (namely the left conical surface) is the first taper angle α1. The first helical conical surface 421 of the tapered hole forms a left taper 95 and is subjected to a left-direction distribution 97. The angle between two prime lines of the second helical conical surface 422 of the tapered hole (namely the right conical surface) is the second taper angle α2. The second helical conical surface 422 of the tapered hole forms a right taper 96 and is subjected to a right-direction distribution 98. The tapered direction corresponding to the first taper angle α1 is opposite to the tapered direction corresponding to the second taper angle α2. The prime line is the intersecting line of the conical surface and the plane passing through the cone axis 01. The shape formed by the first helical conical surface 421 and the second helical conical surface 422 of the bidirectional tapered hole is the same as the shape of the helical outer surface of a cyclotron body formed by two inclined sides of a right-angle trapezoid union. The right-angle trapezoid union comprises two right-angle trapezoids with same bottom sides and same top sides but different right-angle sides, the two right-angle trapezoids are connected to each other at the bottom sides symmetrically and coincident with the plane passing through the central axis of the cylindrical body 2. The cyclotron body is formed by rotating the right-angle trapezoid union in a circumferential direction at an even speed around its right-angle side and at the same time moving the right-angle trapezoid union axially towards the central axis of the cylindrical body 2 at an even speed. The right-angle trapezoid union is a special body which comprises two right-angle trapezoids with same bottom sides and same top sides but different right-angle sides, the two right-angle trapezoids are connected to each other at the bottom sides symmetrically, and the top sides are respectively located at two ends of the right-angle trapezoid union.

In the bidirectional tapered internal thread and the traditional thread, when in a transmission connection, it can support the load bidirectionally through the screwed connection between the bidirectional tapered hole 41 and the special tapered body 7 of the traditional external thread 9. When the external thread 9 and the internal thread 6 form a thread pair 10, there must be clearance 101 between the bidirectional tapered hole 41 and the special tapered body 7 of the traditional external thread 9. If there is oil or other lubrication medium between the internal thread 6 and the external thread 9, it will be easy to form a supporting oil film. The clearance 101 is conducive to the formation of the supporting oil film. The thread connection pair 10 is equivalent to a set of sliding bearing pairs composed of one and/or several pairs of sliding bearings. Each section of the bidirectional tapered internal thread 6 bidirectional accommodates a corresponding section of the traditional external thread 9, which form a pair of sliding bearings. The amount of the formed sliding bearings can be adjusted according to the application conditions. Namely, the amount of the accommodating and accommodated thread sections in effective bidirectional engagement or embracement of the bidirectional tapered internal thread 6 and the traditional external thread 9, can be designed according to the application conditions. The special tapered body 7 of the traditional external thread 9 is accommodated by the tapered hole 4 and positioned in multiple directions such as radial, axial, angular, and circumferential directions, which realizes a special technology of the combination of the cone pair and thread pair, ensuring the accuracy, efficiency and reliability of the transmission connection of the traditional thread and the tapered thread, especially the bidirectional tapered internal thread.

In the bidirectional tapered internal thread and the traditional thread, when in a fastening or sealing connection, the technical performance is achieved through the screw connection between the bidirectional tapered hole 41 and the special tapered body 7 of the traditional external thread 9, namely through the first helical conical surface 421 of the tapered hole and the special conical surface 72 of the traditional external thread 9 sizing till interference fit, and/or the second helical conical surface 422 of the tapered hole and the special conical surface 72 of the traditional external thread 9 sizing till interference fit. According to the application conditions, it can support load in one direction and/or simultaneously in two directions. Namely, in the bidirectional tapered hole 41 and the special tapered body 7 of the traditional external thread 9, under the guide of the helical line, the inner and outer diameters of the internal cone and the external cone are centered till the first helical conical surface 421 of the tapered hole and the special conical surface 72 of the special tapered body 7 of the traditional external thread 9 are held together to achieve the interference contact, and/or till the second helical conical surface 422 of the tapered hole and the special conical surface 72 of the special tapered body 7 of the traditional external thread 9 are held together to achieve the interference contact, thus achieving the technical performances of the mechanical structures, such as connection, locking, anti-loosening, bearing, fatigue and sealing.

Therefore, the technical performances of the connection pair 10 of the bidirectional tapered internal thread and the traditional thread, such as the transmission accuracy, transmission efficiency, load-supporting capacity, locking force of self-locking, anti-loosening capacity, sealing performance, and reusability are related to the first taper angle α1 and the second taper angle α2. The first taper angle α1 corresponds to the first helical conical surface 421 of the tapered hole and the left taper 95 formed by it. The second taper angle α2 corresponds to the second helical conical surface 422 of the tapered hole and the right taper 96 formed by it. The technical performances are also related to the special conical surface 72 of the special tapered body 7 of the traditional external thread 9 and its conic degree, and the special conical surface 72 is formed by the contact between the bidirectional tapered internal thread 6 with the traditional external thread 9. The friction coefficient, processing quality, and application conditions of the material of the columnar body 3 and the cylindrical body 2 also have a certain effect on the technical performances.

In the bidirectional tapered internal thread and the traditional thread, when the right-angle trapezoid union makes one revolution at a constant speed, the moving distance of the right-angle trapezoid union in the axial direction is at least double of the sum of the lengths of the right-angle sides of two right-angle trapezoids with different right-angle sides, same bottom sides and same top sides. This structure ensures that the first helical conical surface 421 of the tapered hole and the second helical conical surface 422 of the tapered hole have sufficient lengths, so as to ensure a sufficiently effective contact area, strength, and efficiency required for helical movement when the conical surface 42 of the bidirectional tapered hole is fitted with the special conical surface 72 of the special tapered body 7 of the traditional external thread 9.

In the bidirectional tapered internal thread and the traditional thread, when the right-angle trapezoid union makes one revolution at a constant speed, the moving distance of the right-angle trapezoid union in the axial direction is equal to the sum of the lengths of the right-angle sides of two right-angle trapezoids with different right-angle sides, same bottom sides and same top sides. This structure ensures that the first helical conical surface 421 of the tapered hole and the second helical conical surface 422 of the tapered hole have sufficient lengths, so as to ensure a sufficiently effective contact area, strength, and efficiency required for helical movement when the conical surface 42 of the bidirectional tapered hole is fitted with the special conical surface 72 of the special tapered body 7 of the traditional external thread 9.

In the bidirectional tapered internal thread and the traditional thread, the first helical conical surface 421 of the tapered hole and the second helical conical surface 422 of the tapered hole are both continuous helical surfaces or discontinuous helical surfaces.

In the bidirectional tapered internal thread and the traditional thread, one end and/or both ends of the columnar body 3 can be the screw-in end screwed into the connection hole of the cylindrical body 2, and the connection hole is a threaded hole provided on the nut body 21.

Compared with the existing technology, the advantages of the connection pair 10 of the bidirectional tapered internal thread and the traditional thread are as follows. It has a reasonable design and a simple structure. The fastening and connection functions can be achieved through sizing the cone pair consisted of the internal and external cones till interference fit. Besides, it is easy to operate, has a large locking force, a large load-supporting value, a good anti-loosening performance, a high transmission efficiency and precision, a good mechanical sealing effect, a good stability, an ability to prevent loosening during connection, and the self-locking and self-positioning functions.

### The Second Embodiment

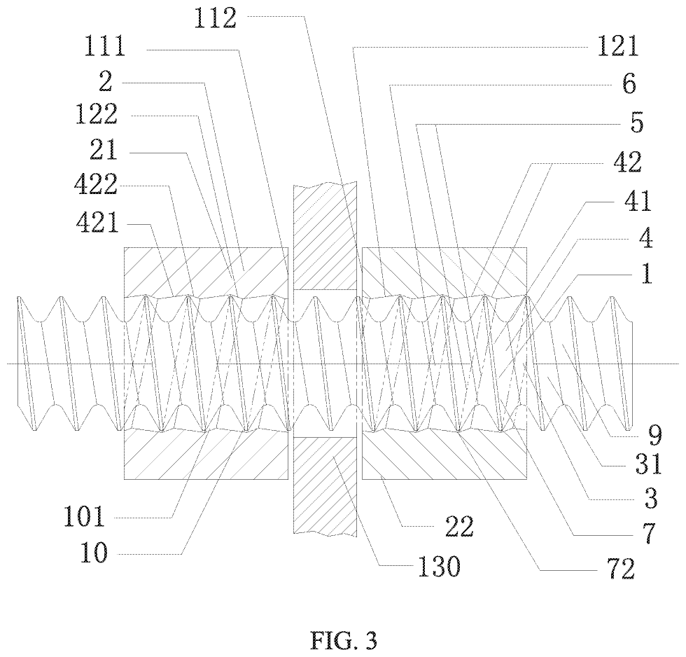

As shown in FIG. 3, the structure, principle and implementation steps of this embodiment are similar to those of the first embodiment, the difference is that, the connection structure of a bolt with the traditional thread 9 and double nuts with asymmetrically bidirectional tapered internal thread 6 is used in the second embodiment. The cylindrical body 2 includes double nuts including a nut body 21 and a nut body 22. The nut body 21 is located at the left side of the fastened workpiece 130, and the nut body 22 is located at the right side of the fastened workpiece 130. The bolt and the double nuts are rigidly connected with the fastened workpiece 130 when in use. The rigid connection means that the supporting surface of the nut and the supporting surface of the workpiece 130 are mutually supported, including a locking support surface 111 and a locking support surface 112. The workpiece 130 refers to the objects to be connected including the workpiece 130.

In the embodiment, the thread-working supporting surfaces are different, including a tapered-thread supporting surface 121 and a tapered-thread supporting surface 122. When the cylindrical body 2 is located at the left side of the fastened workpiece 130, namely the left end surface of the fastened workpiece 130 and the right end surface of the cylindrical body 2 (namely the left nut body 21) are the locking support surfaces 111 between the left nut body 21 and the fastened workpiece 130, the right helical conical surface of the bidirectional tapered thread 1 of the left nut body 21 is the thread-working support surface, namely the tapered-thread supporting surface 122 is the thread-working support surface. That is, the second helical conical surface 422 of the tapered hole of the tapered internal thread 6 and the special conical surface 72 of the traditional external thread 9 are the tapered-thread supporting surfaces 122, and the second helical conical surface 422 of the tapered hole and the special conical surface 72 of the traditional external thread 9 are mutually supported. When the cylindrical body 2 is located at the right side of the fastened workpiece 130, namely the right end surface of the fastened workpiece 130 and the left end surface of the cylindrical body 2 (namely the right nut body 22) are locking support surfaces 112 between the right nut body 22 and the fastened workpiece 130, the left helical conical surface of the bidirectional tapered thread 1 of the right nut body 22 is the thread-working supporting surface, namely the tapered-thread supporting surface 121 is the thread-working supporting surface. That is, the first helical conical surface 421 of the tapered hole of the tapered internal thread 6 and the special conical surface 72 of the traditional external thread 9 are tapered-thread supporting surfaces 121, and the first helical conical surface 421 of the tapered hole and the special conical surface 72 of the traditional external thread 9 are mutually supported.

The connection holes are provided in the nut body 21 and the nut body 22.

### The Third Embodiment

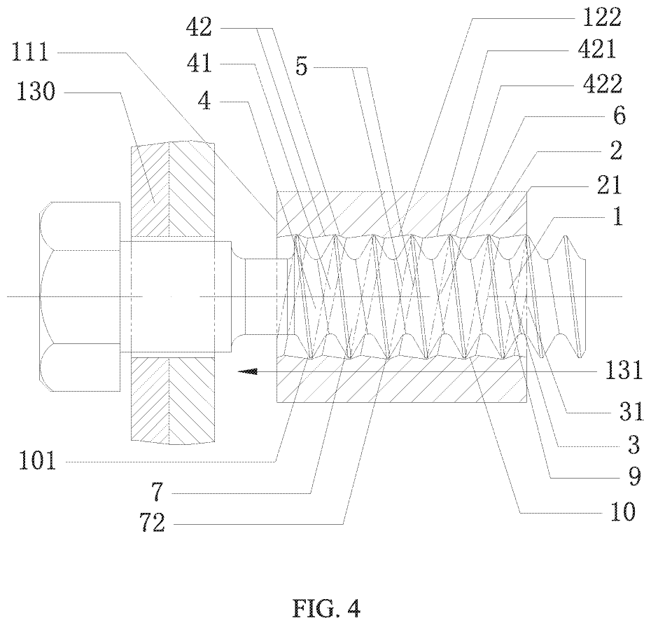

As shown in FIG. 4, the structure, principle and implementation steps of this embodiment are similar to those of the first embodiment and the second embodiment, except that the connection structure of a bolt with the traditional thread and a single nut with the asymmetrically bidirectional tapered thread 1 is used in this embodiment. The bolt body has a hexagonal head larger than the screw body 31. When the hexagonal head of the bolt is on the left, the cylindrical body 2 (namely the nut body 21 or the single nut) is located at the right side of the fastened workpiece 130. The bolt and the single nut are rigidly connected with the fastened workpiece 130 when in use. The rigid connection means that the end surface of the nut body 21 and the end surface of the workpiece 130 which are facing to each other are mutually supporting surfaces. The supporting surfaces refer to the supporting surfaces 111. The workpiece 130 refers to the objects to be connected including the workpiece 130.

In the embodiment, the thread-working supporting surface is the tapered-thread supporting surface 122, and the cylindrical body 2 (namely the nut body 21 or the single nut) is located at the right side of the fastened workpiece 130. When the bolt and the single nut is working, the right end surface of the workpiece 130 and the left end surface of the nut body 21 are locking support surfaces 111 between the nut body 21 and the fastened workpiece 130. The left helical conical surface of the bidirectional tapered thread 1 of the nut body 21 is the thread-working supporting surface, namely the tapered-thread supporting surface 122 is the thread-working supporting surface of the bidirectional tapered thread 1. That is, the first helical conical surface 421 of the tapered hole of the tapered internal thread 6 and the special conical surface 72 of the traditional external thread 9 are tapered-thread supporting surfaces 122, and the first helical conical surface 421 of the tapered hole and the special conical surface 72 of the traditional external thread 9 are mutually supported.

In the embodiment, when the hexagonal head of the bolt is located at the right side, the structure, principle and implementation steps are similar to this embodiment.

### The Fourth Embodiment

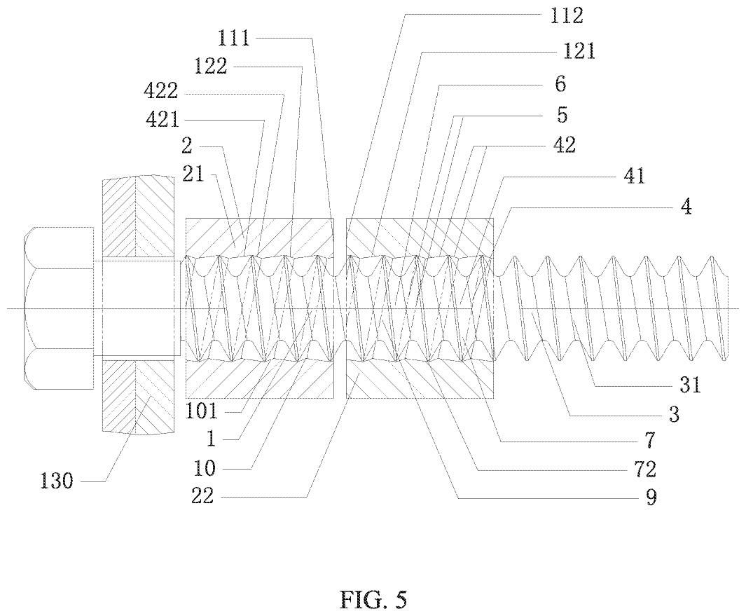

As shown in FIG. 5, the structure, principle, and implementation steps of this embodiment are similar to those of the first embodiment and the second embodiment, except that the positional relationship between the double nuts and the fastened workpiece 130 is different. The double nuts include a nut body 21 and a nut body 22, and the bolt body has a hexagonal head larger than the screw body 31. The hexagonal head of the bolt is on the left, the nut body 21 and nut body 22 are both located at the right side of the fastened workpiece 130. When the bolt and the double nuts are working, the nut body 21 and nut body 22 are non-rigidly connected with the fastened workpiece 130. The non-rigid connection means that the end surfaces of the double nuts (namely the nut body 21 and nut body 22) facing to each other are mutually supporting surfaces, including the locking support surface 111 and the locking support surface 112. The non-rigid connection is mainly used in non-rigid materials or non-rigid connection workpieces 130 such as transmission parts or to meet the needs through double nuts installation. The workpiece 130 refers to the connected object including the workpiece 130.

In the embodiment, the thread-working supporting surfaces are different, including the tapered-thread supporting surface 121 and the tapered-thread supporting surface 122. The cylindrical body 2 comprises a left nut body 21 and a right nut body 22. The right end surface (namely the locking support surface 111) of the left nut body 21 faces to and contacts directly with the left end surface (namely the locking support surface 112) of the right nut body 22, and they are mutually supported and locked. When the right end surface of the left nut body 21 is the locking support surface 111, the right helical conical surface of the bidirectional tapered thread 1 of the left nut body 21 is the thread-working supporting surface, namely the tapered-thread supporting surface 122 is the thread-working supporting surface. That is, the second helical conical surface 422 of the tapered hole of the tapered internal thread 6 and the special conical surface 72 of the traditional external thread 9 are tapered-thread supporting surfaces 122, and the second helical conical surface 422 of the tapered hole and the special conical surface 72 of the traditional external thread 9 are mutually supported. When the left end surface of the right nut body 22 is the locking support surface 112, the left helical conical surface of the bidirectional tapered thread 1 of the right nut body 22 is the thread-working supporting surface, namely the tapered-thread supporting surface 121 is the thread-working supporting surface. That is, the first helical conical surface 421 of the tapered hole of the tapered internal thread 6 and the special conical surface 72 of the traditional external thread 9 are tapered-thread supporting surfaces 121, and the first helical conical surface 421 of the tapered hole and the special conical surface 72 of the traditional external thread 9 are mutually supported.

In the embodiment, when the internal cylindrical body 2 (namely the nut body 21 adjacent to the fastened workpiece 130) has been effectively combined with the columnar body 3 (namely the screw body 31 or the bolt), namely the internal thread 6 and the external thread 9 which consist of the thread connection pair 10 are effectively held together, the external cylindrical body 2 (namely the nut body 22 that is not adjacent to the fastened workpiece 130) can be kept intact and/or removed to leave only one nut according to the application conditions (for example, the application field that has requires for the lightweight of the equipment, or the application field that doesn't need double nuts to ensure the connection reliability, or other application fields). The removed nut body 22 is not used as a connection nut but only as an installation process nut. The internal thread of the installation process nut can be processed to the bidirectional tapered thread, or an unidirectional tapered thread, or any other traditional thread that can be screwed with the thread of the bolt, such as a triangular thread, a trapezoid thread, a zigzag thread, etc., but not limited to the above. Any suitable thread can be applied to ensure the connection reliability. The thread connection pair 10 is a closed-loop fastening technology system. When the internal thread 6 and the external thread 9 of the thread connection pair 10 are effectively combined together, the thread connection pair 10 will become an independent technical system, but not relying on the technical compensation of a third party to ensure the technical effectiveness of the connection technology system. That is, the effectiveness of the thread connection pair 10 will not be affected even if there is no support from other objects, such as when there is a gap between the thread connection pair 10 and the fastened workpiece 130, which will help to greatly reduce the weight of the equipment, remove the invalid load, and improve the technical performance of the equipment such as the effective load capacity, the braking performance, and the energy saving and emission reducing ability. This is a unique technical advantage that is not available in other thread technology, but only available in the connection pair 10 of the bidirectional tapered internal thread and the traditional thread no matter it is rigidly or non-rigidly connected with the fastened workpiece 130.

In the embodiment, when the hexangular head of the bolt is located on the right side, the nut body 21 and the nut body 22 are both located at the left side of the fastened workpiece 130, the structure, principle, and implementation steps are similar to this embodiment.

### The Fifth Embodiment

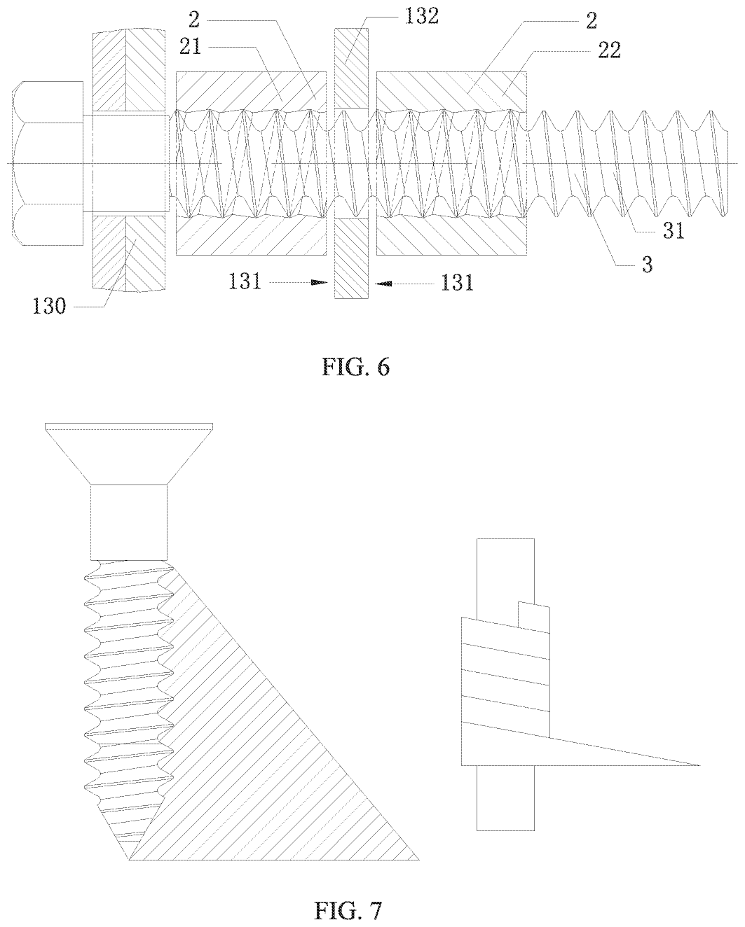

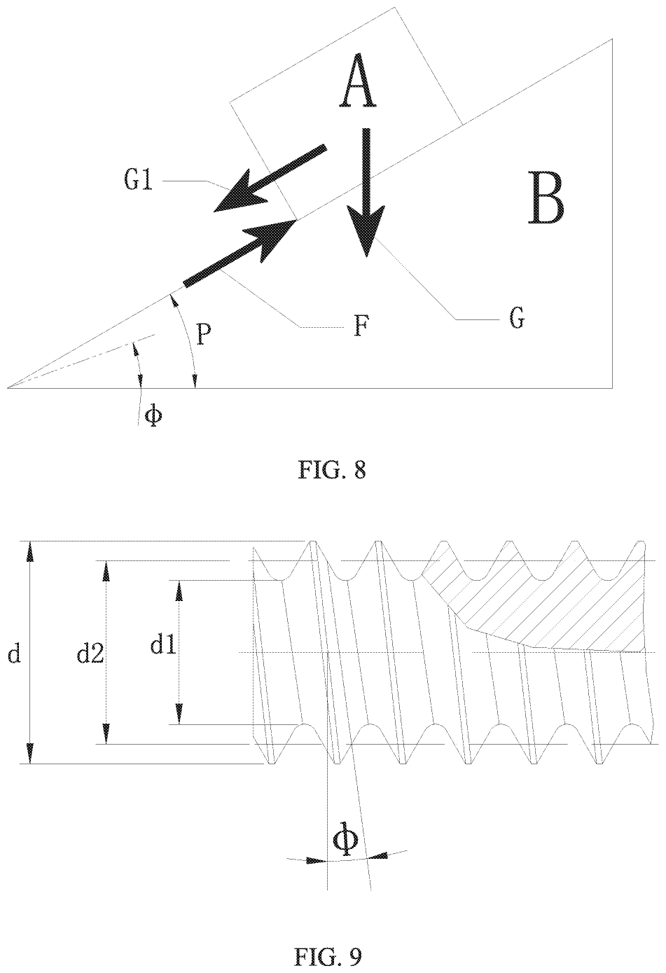

As shown in FIG. 6, the structure, principle and implementation steps of this embodiment are similar to those of the first embodiment and the fourth embodiment, except that a spacer such as a gasket 132 is provided between the nut body 21 and the nut body 22 in this embodiment based on the fourth embodiment. The right end surface of the left nut body 21 faces to and contacts indirectly with the left end surface of the right nut body 22 through the gasket 132, and they are mutually supported and locked. That is, relationship between the right end surface of the left nut body 21 and the left end surface of the right nut body 22 has changed from directly mutual lock-and-support to indirectly mutual lock-and-support.

The specific embodiments described herein are merely illustrative of the spirit of the disclosure. Various modifications, additions or equivalents can be made to the described specific embodiments by the skilled in the art to which the present disclosure pertains, without departing from the spirit of the present disclosure or going beyond the range of the appended claims.

Although many terms are used in the disclosure, such as tapered thread 1, cylindrical body 2, nut body 21, nut body 22, columnar body 3, screw body 31, tapered hole 4, bidirectional tapered hole 41, conical surface 42 of bidirectional tapered hole, first helical conical surface 421 of tapered hole, first cone angle α1, second helical conical surface 422 of tapered hole, second taper angle α2, internal helical line 5, internal thread 6, special tapered body 7, special conical surface 72, external thread 9, olive-like shape 93, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror-image, sleeve, shaft, single tapered body, double tapered bodies, cone, internal cone, tapered hole, external cone, tapered body, cone pair, helical structure, helical motion, thread body, complete unit thread, axial force, axial force angle, counter-axial force, counter-axial force angle, centripetal force, counter-centripetal force, collinear but reverse, internal stress, bidirectional force, unidirectional force, sliding bearing, sliding bearing pair, locking support surface 111, locking support surface 112, tapered-thread supporting surface 122, tapered-thread supporting surface 121, non-entity space, material entity, workpiece 130, locking direction 131 of nut body, non-rigid connection, non-rigid material, transmission parts, gasket 132, the possibility of using other terms are not excluded. The terms are used only in order to describe and explain the essence of the present disclosure more conveniently, it is contrary to the spirit of the present disclosure to interpret them as any additional limitation.

We claim:

1. A connection structure of a traditional thread and an internal thread outlining a bidirectional tapered olive-like shape having a smaller left taper, namely a connection structure of a traditional thread and an internal thread outlining an asymmetrically bidirectional tapered olive-like shape having a smaller left taper, comprising an external thread (9) and an internal thread (6) threaded with each other, wherein, for the internal thread (6) outlining an asymmetrically bidirectional tapered olive-like shape having a smaller left taper, its complete unit thread forms an asymmetrically bidirectional tapered hole (41) in an olive-like shape (93) having a large middle part and two small ends, the left taper (95) being smaller than the right taper (96), the thread body of the internal thread (6) is a bidirectional tapered hole (41) in a helical shape on the inner surface of a cylindrical body (2) and is present in form of a non-entity space, the thread body of the external thread (9) is a special tapered body (7) in a helical shape on the outer surface of a column body (3) and is present in form of a material entity, the special tapered body (7) is formed through the clasping contact and fitting between the tooth of the traditional external thread (9) and the bidirectional tapered internal thread (6), the left conical surface of the asymmetrically bidirectional tapered internal thread (6) forms the left taper (95) corresponding to a first taper angle (α1), the right conical surface forms a right taper (96) corresponding to a second taper angle (α2), the left taper (95) and the right taper (96) are opposite in direction and different in conic degree, the internal thread (6) and the external thread (9) are connected through the tapered hole accommodating the tapered body till the internal and external conical surfaces are supported mutually, the technical performances mainly depend on the conical surface and the conic degree of the fitted thread body, preferably, 0°<the first taper angle (α1<53°), 0°<the second taper angle (α2)<53°, in some specific fields, preferably, 53°≤the second taper angle (α2)<180.

2. The connection structure according to claim 1, wherein the bidirectional tapered internal thread (6) in an olive-like shape (93) comprises a first helical conical surface (421) of the tapered hole, a second helical conical surface (422) of the tapered hole and an internal helical line (5), the shape formed by the first helical conical surface (421) and the second helical conical surface (422) of the bidirectional tapered hole is the same as the shape of the helical outer surface of a cyclotron body formed by two inclined sides of a right-angle trapezoid union, the right-angle trapezoid union comprises two right-angle trapezoids with same bottom sides and same top sides but different right-angle sides, the two right-angle trapezoids are connected to each other at the bottom sides symmetrically and coincident with the plane passing through the central axis of the cylindrical body (2), the cyclotron body is formed by rotating the right-angle trapezoid union in a circumferential direction at an even speed around its right-angle side and at the same time moving the right-angle trapezoid union axially towards the central axis of the cylindrical body (2) at an even speed.

3. The connection structure according to claim 2, wherein, when the right-angle trapezoid union makes one revolution at a constant speed, the moving distance of the right-angle trapezoid union in the axial direction is at least double of the sum of the lengths of the right-angle sides of two right-angle trapezoids.

4. The connection structure according to claim 2, wherein, when the right-angle trapezoid union makes one revolution at a constant speed, the moving distance of the right-angle trapezoid union in the axial direction is equal to the sum of the lengths of the right-angle sides of two right-angle trapezoids.

5. The connection structure according to claim 1, wherein the first helical conical surface (421) of the tapered hole, the second helical conical surface (422) of the tapered hole, and the internal helical line (5) are all continuous helical surfaces or discontinuous helical surfaces; the special tapered body (7) has special conical surfaces (72) that are all continuous helical surfaces or discontinuous helical surfaces.

6. The connection structure according to claim 1, wherein, the internal thread (6) is consisted of two tapered holes (4) with same bottom surfaces and same top surfaces but of different conic heights, the two tapered holes are symmetrically engaged with each other at bottom surfaces in contrary directions, and the top surfaces are located at two ends of the bidirectional tapered hole (41), in an asymmetrically bidirectional tapered thread (1) in an olive-like shape (93), the top surfaces of adjacent bidirectional tapered holes (41) are respectively engaged with each other in helical shape to form an asymmetrically bidirectional tapered internal thread (6) in an olive-like shape (93).

7. The connection structure according to claim 1, wherein the above-mentioned traditional thread includes any of a triangular thread, a trapezoid thread, a zigzag thread, a rectangular thread and an arc thread, but not limited to the above, any other suitable shape-like thread can be adopted, including the traditional thread whose thread body or tooth are deformed and screwed with the above bidirectional tapered thread (6), which conforms to the spirit of the present disclosure.

8. The connection structure according to claim 1, wherein the bidirectional tapered internal thread (6) has the capability of fitting the traditional external thread (9), and includes a single threaded section that is an incomplete tapered body, namely the single threaded section is an incomplete unit thread, the traditional external thread (9) fitted by it is a dissimilated traditional thread having a thread body of a special tapered thread (1), in a thread pair (10) consisted of the internal thread (6) and the external thread (9), the bidirectional tapered hole (41) in helical shape and the special tapered body (7) in helical shape are matched with each other to form the cone pair or thread pair (10) section by section, and the contact surface between the special conical surface (72) and the first helical conical surface (421) and the second helical conical surface (422) of the tapered hole is the supporting surface, under the guide of the helical line, the inner and outer diameters of the internal cone and the external cone are centered till the conical surface (42) of the bidirectional tapered hole and the special conical surface (72) are held together to enable the helical conical surface supporting the load in one direction and/or simultaneously in two directions and/or till the sizes are in self-positioning contact and/or till the sizes are in interference contact to realize self-locking.

9. The connection structure according to claim 1, wherein, when a cylindrical body (2) has been effectively combined with the columnar body (3), namely the internal thread (6) and the external thread (9) which consist of the thread connection pair (10) are effectively held together, the other cylindrical body (2) can be kept intact and/or removed, the removed cylindrical body (2) is not used as a connection nut but only as an installation process nut, the internal thread of the installation process nut includes the bidirectional tapered thread (1), or an unidirectional tapered thread, or any other traditional thread that can be screwed with the thread of the columnar body (3).

10. The connection structure according to claim 1, wherein the cylindrical body (2) includes cylinders and/or non-cylinders and other workpieces and objects that need to be provided with the bidirectional tapered internal threads (6) on their inner surfaces, the inner surfaces include cylindrical surfaces and/or non-cylindrical surfaces such as conical surfaces.
